(19) United States
(12) Patent Application Publication
(10) Pub. No.: US 2025/0322252 A1
(43) Pub. Date: Oct. 16, 2025

(54) OFFLINE PRE-TRAINING AND ONLINE FINE-TUNING METHOD AND APPARATUS BASED ON REINFORCEMENT LEARNING

(71) Applicant: FOUNDATION OF SOONGSIL UNIVERSITY-INDUSTRY COOPERATION, Seoul (KR)

(72) Inventors: Minhae KWON, Seoul (KR); Dongsu LEE, Seoul (KR)

(73) Assignee: FOUNDATION OF SOONGSIL UNIVERSITY-INDUSTRY COOPERATION, Seoul (KR)

(21) Appl. No.: 18/828,913

(22) Filed: Sep. 9, 2024

(30) Foreign Application Priority Data
Apr. 11, 2024 (KR) 10-2024-0048666

(51) Int. Cl. G06N 3/092

(52) U.S. Cl. CPC G06N 3/092

(57) ABSTRACT

An offline pre-training and online fine-tuning apparatus based on reinforcement learning includes a data management unit collecting and processing data for offline reinforcement learning in advance; an offline model training unit training an offline policy network and an offline state-action value function network using a previously collected dataset that includes a state, an action, a next state, a reward, and an accumulated reward collected by the data management unit; and an online model training unit performing fine-tuning to update parameters of the offline policy network using an online dataset that includes action information determined based on state information acquired through interaction with the offline policy network and an environment, state information at a next time point according to the action information, and the reward, and the previously collected dataset.

### CROSS-REFERENCE TO RELATED APPLICATION

This application claims priority under 35 U.S.C. § 119(a) to Korean Patent Application No. 10-2024-0048666 filed in the Korean Intellectual Property Office on Apr. 11, 2024, the entire contents of which are incorporated herein by reference.

### BACKGROUND

### (a) Technical Field

The present disclosure relates to an offline pre-training and online fine-tuning method and apparatus based on reinforcement learning.

### (b) Background Art

For tasks that require decision-making based on interaction with the environment, a deep reinforcement learning method using a deep neural network is considered as a promising method. In the reinforcement learning, an agent trains a policy so that it may perform actions that may obtain an optimal reward in a specific environment.

In the case of the existing online reinforcement learning, the policy is trained through real-time interaction with the environment. The online reinforcement learning method for physical devices (vehicles, drones, robots, etc.) may cause significant losses from economic and social perspectives. Accordingly, the offline reinforcement learning method that performs training based on pre-collected data without considering online interaction are being proposed.

However, the offline reinforcement learning suffers from the distributional shift problem that is experienced in existing supervised learning. This occurs due to the mismatch between a training dataset and a test dataset, that is, because the training dataset does not cover all the data. When a pessimistic evaluation method is used to solve this problem, there is a limitation in that it is difficult to find the optimal policy.

### SUMMARY OF THE DISCLOSURE

In order to solve the problems of the above-mentioned prior art, the present disclosure provides an offline pre-training and online fine-tuning method and apparatus based on reinforcement learning, which can improve a policy by training a policy in an offline environment using a previously collected dataset and then additionally performing training in an online environment.

In order to achieve the above-described objects, according to one embodiment of the present disclosure, there is provided an offline pre-training and online fine-tuning apparatus based on reinforcement learning, including: a data management unit collecting and processing data for offline reinforcement learning in advance; an offline model training unit training an offline policy network and an offline state-action value function network using a previously collected dataset that includes a state, an action, a next state, a reward, and an accumulated reward collected by the data management unit; and an online model training unit performing fine-tuning to update parameters of the offline policy network using an online dataset that includes action information determined based on state information acquired through interaction with the offline policy network and an environment, state information at a next time point according to the action information, and the reward, and the previously collected dataset.

The offline model training unit may perform adaptation for building a new state-action value function network matching the offline policy network, and the online model training unit may update parameters of the new state-action value function network according to the offline policy network and the adaptation using the online dataset and the previously collected dataset.

The online model training unit may initialize all or at least a part of the parameters of the new state-action value function according to the offline policy network and the adaptation.

The data management unit may collect observation information and action information through observation equipment, match the observation information and the action information with observation information at a next time point, calculate a reward using the matched observation information, action information, and observation information at the next time point, and store the observation information, the action information, the observation information at the next time point, and the reward as the previously collected dataset.

The offline model training unit may sample at least some data from the previously collected dataset, calculate and update an objective function of a state-action value function network that evaluates a value of a specific state-action pair using the sampled data, and calculate and update the objective function of the offline policy network.

The online model training unit may load the offline policy network pre-trained by the offline model training unit, collect initial observation information, determine an action using the offline policy network and the initial observation information, collect observation information at a next time point according to the determined action, acquire a reward using the initial observation information, the action, and the observation information at a next time point, and update the parameters of the offline policy network using the initial observation information, the action, the observation information at the next time point, and the reward.

According to another aspect of the present disclosure, there is provided an offline pre-training and online fine-tuning apparatus based on reinforcement learning, including: a processor; and a memory connected to the processor, wherein the memory stores program instructions executed by the processor to collect data for offline reinforcement learning in advance, process the collected data into a previously collected dataset that includes a state, an action, a next state, a reward, and an accumulated reward, train an offline policy network and an offline state-action value function network using the previously collected dataset, and update parameters of the offline policy network using an online dataset that includes action information determined based on state information acquired through interaction with the offline policy network and an environment, state information at a next time point according to the action information, and the reward, and the previously collected dataset.

According to still another aspect of the present disclosure, there is provided an offline pre-training and online fine-tuning method based on reinforcement learning performed on a device including a processor and memory, including: (a) collecting and processing data for offline reinforcement learning in advance; (b) training an offline policy network and an offline state-action value function network using a previously collected dataset that includes a state, an action, a next state, a reward, and an accumulated reward collected by the data management unit; and (c) performing fine-tuning to update parameters of the offline policy network using an online dataset that includes action information determined based on state information acquired through interaction with the offline policy network and an environment, state information at a next time point according to the action information, and a reward, and the previously collected dataset.

According to the present disclosure, by pre-training the policy through more practical offline reinforcement learning applicable to the mission-critical technologies, etc., and optimizing the model with a more optimal policy using the online reinforcement learning, it is possible to help train the high-performance policy regardless of the given dataset.

### BRIEF DESCRIPTION OF DRAWINGS

FIG. 1 is a diagram illustrating a configuration of an offline pre-training and online fine-tuning apparatus based on reinforcement learning according to a preferred embodiment of the present disclosure.

FIG. 2 is a diagram illustrating a flowchart of a data collection and processing process according to the present embodiment.

FIG. 3 is a diagram illustrating a flowchart of an offline reinforcement learning process using prior data according to the present embodiment.

FIG. 4 is a diagram illustrating a flowchart of an online fine-tuning process according to the present embodiment.

FIG. 5 is a diagram illustrating various examples of parameter initialization according to the present embodiment.

FIG. 6 is a diagram illustrating an offline pre-training and online fine-tuning framework based on reinforcement learning according to a preferred embodiment of the present disclosure.

### DETAILED DESCRIPTION

Since the present disclosure may be variously modified and have several exemplary embodiments, specific exemplary embodiments will be illustrated in the accompanying drawings and be described in detail in a detailed description. However, it is to be understood that the present disclosure is not limited to a specific embodiment, but includes all modifications, equivalents, and substitutions without departing from the technical scope and spirit of the present disclosure.

The terms used in the present specification are used only in order to describe specific embodiments rather than limiting the present disclosure. Singular forms include plural forms unless the context clearly indicates otherwise. It should be further understood that the term “include” or “have” used in the present specification specifies the presence of features, numerals, steps, operations, components, parts mentioned in the present specification, or combinations thereof, but do not preclude the presence or addition of one or more other features, numerals, steps, operations, components, parts, or combinations thereof.

In addition, components of the embodiments described with reference to each drawing are not limitedly applied only to the corresponding embodiment, and may be implemented to be included in other embodiments within the scope of maintaining the technical spirit of the present disclosure. In addition, it goes without saying that these components may also be re-implemented as one embodiment in which a plurality of embodiments are integrated, even if a separate description is omitted.

In addition, in the description with reference to the accompanying drawings, regardless of reference numerals, the same components will be given the same or related reference numerals and duplicate description thereof will be omitted. When it is decided that the detailed description of the known art related to the present disclosure may unnecessary obscure the gist of the present disclosure, a detailed description therefor will be omitted.

The present embodiment considers a method of improving a policy by training the policy in an offline environment using a prior-collected dataset and then additionally performing training in an online environment. In this method, the problem is efficiently solved through various methodologies to accelerate online fine-tuning of a pre-trained policy.

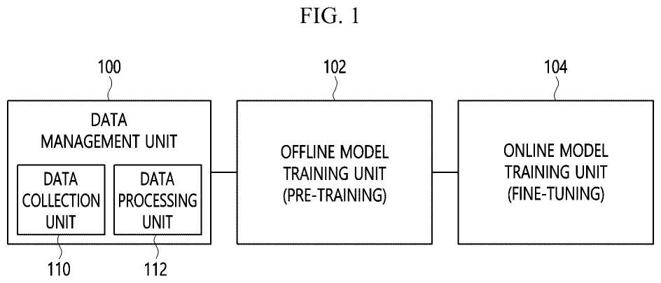

FIG. 1 is a diagram illustrating a configuration of an offline pre-training and online fine-tuning apparatus based on reinforcement learning according to a preferred embodiment of the present disclosure.

As illustrated in FIG. 1, the apparatus according to the present embodiment may include a data management unit 100, an offline model training unit 102, and an online model training unit 104.

The data management unit 100 collects data for offline learning in advance and processes the collected data.

The data management unit 100 includes a data collection unit 110 and a data processing unit 112.

The data collection unit 110 collects data for a domain of the problem to be solved in advance. The form of the collected data may be any form, and prior data is then processed by the data processing unit 112 and used for neural network model learning.

The data processing unit 112 processes the prior data so that it may match the Markov decision process (MDP) of the problem to be solved.

In addition, the data processing unit 112 performs correction of incorrect data, data normalization, removal of abnormal data, etc., and for example, in the case of an image-based dataset, performs an operation of adjusting pixel values, etc.

In the MDP, multi-task reinforcement learning is defined as a tuple [symbol] s∈ [symbol] refers to state information (state) of the environment, a∈ [symbol] refers to an action of an entity, T refers to a state transition probability, [symbol] refers to a set of tasks g, [symbol] refers to a reward function, and γ refers to a discount factor. Here, the entity aims to train a policy π(a|s;g) that may maximize an accumulated reward regardless of a given task within a finite time range.

The multi-task reinforcement learning may be applied to train a driving policy of each autonomous vehicle in various scenarios or a flight policy of each drone in a drone network.

In the MDP, there is an assumption that the entity can fully observe all the state information of the environment.

However, in the real environment, it is limited to perfectly observe all the state information, so in the present embodiment, the reinforcement learning problem is defined through a partially observable MDP (POMDP) that performs decision-making based on partial state information.

The POMDP is defined as a tuple [symbol] , o∈ [symbol] refers to the information that the entity can observe, and Ω refers to an observation probability.

However, hereinafter, for the convenience of description, the information that the entity can actually observe is also defined as the state information.

In the present embodiment, the prior data may include real-world data that does not follow the Markov decision model.

Therefore, in order to utilize the prior data, it is necessary to process the collected prior data based on the Markov decision model of an ego entity.

The data processing unit 112 processes the prior data collected by the data collection unit 110 into data including a state, an action, a state at the next time point, and a reward.

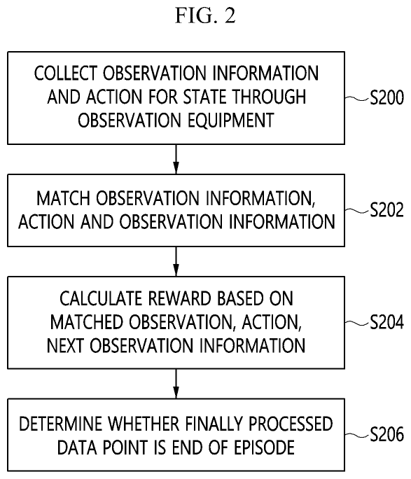

FIG. 2 is a diagram illustrating a flowchart of a data collection and processing process according to the present embodiment.

Referring to FIG. 2, the data management unit 100 collects observation information and action information about the environment through observation equipment (step 200).

Thereafter, the observation information, the action information, and observation information at a next time point are matched (step 202), and a reward is calculated based on the matched observation, action, and observation information at the next time point (step 204).

Finally, it is determined whether the finally processed data point is an end of an episode (step 206).

Through the process as illustrated in FIG. 2, a previously collected dataset including a state, an action, a state at the next time point, and a reward is stored in an offline buffer.

The offline model training unit 102 trains a neural network model using the previously collected dataset.

In this case, the neural network model may include a policy network and a state-action value function network.

The policy network is a network that outputs an action according to a given state, and the state-action value function network is defined as a network that evaluates a value of a specific state-action pair.

The objective function for training the policy network may be defined as follows, including behavior cloning (BC).

$${𝔼}_{( o , a ) ∼ {𝒟}_{off} , \tilde{a} ∼ {π}_{ϕ} ( \cdot \vert o )} [ - {( \underbrace{Q ( o , \tilde{a} ) - α log {π}_{ϕ} ( \tilde{a} \vert o )} )}_{vanilla RL objective} - {\underbrace{log {π}_{ϕ} ( a \vert o )}}_{BC} ] \qquad [ Equation 1 ]$$

wherein, α is an importance weight.

The objective function for training the state-action value function network may be defined as follows.

$${𝔼}_{( o , a , {o}^{′} , r ) ∼ {𝒟}_{off} , {\tilde{a}}^{′} ∼ {π}_{ϕ} ( \cdot \vert {o}^{′} )} [ {( {\underbrace{( r + γ {min}_{j ∈ \{ 1 , … , m , … , M \}} {\hat{Q}}_{j} ( {o}^{′} , {\tilde{a}}^{′} ) - α log {π}_{ϕ} ( {\tilde{a}}^{′} \vert {o}^{′} ) )}}_{TD - target with clipped minimum Q} - {Q}_{m} ( o , a ) )}^{2} ] \qquad [ Equation 2 ]$$

The policy and state-action value function network is not limited thereto, and it is assumed that it includes a regularization term capable of efficiently training the policy of the given dataset.

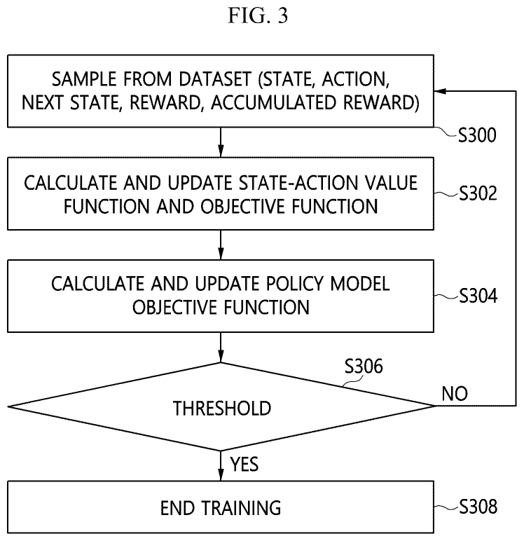

FIG. 3 is a diagram illustrating a flowchart of an offline reinforcement learning process using prior data according to the present embodiment.

Referring to FIG. 3, the offline model training unit 102 samples the state, the action, the state at the next time point, the reward, and the accumulated reward data from the previously collected dataset (step 300).

Thereafter, the objective function of the state-action value function network is calculated and the parameters are updated (step 302).

Next, the objective function of the policy network is calculated and the parameters are updated (step 304).

Finally, it is determined whether the number of times of training has been met (step 306), and when the number of times of training has been met, the training ends (step 308).

In the case of the online reinforcement learning, since new training samples may be collected through an exploration process, the conservative objective function used in the offline reinforcement learning may have a negative effect on the training process.

Accordingly, the online model training unit 104 according to the present embodiment performs a process of fine-tuning the objective function to fit the online reinforcement learning algorithm during the online reinforcement learning process.

The objective functions of the policy network and the state-action value function network for the online fine-tuning process may be defined as follows, respectively.

$${𝔼}_{o ∼ {𝒟}_{off} ⋃ {𝒟}_{on} , \tilde{a} ∼ {π}_{ϕ} ( \cdot \vert o )} [ - ( {Q}_{θ} ( o , \tilde{a} ) - α log {π}_{ϕ} ( \tilde{a} \vert o ) ) ] \qquad [ Equation 3 ]$$

$${𝔼}_{( o , a , {o}^{′} , r ) ∼ {𝒟}_{off} ⋃ {𝒟}_{on} , {\tilde{a}}^{′} ∼ {π}_{ϕ} ( \cdot \vert {o}^{′} )} [ {( ( r + γ {Q}_{\hat{θ}} ( {o}^{′} , {\tilde{a}}^{′} ) - α log {π}_{ϕ} ( {\tilde{a}}^{′} \vert {o}^{′} ) ) - {Q}_{θ} ( o , a ) )}^{2} ] \qquad [ Equation 4 ]$$

When converting an offline reinforcement learning methodology to an online reinforcement learning methodology to perform the effective fine-tuning, the following methodology may be additionally considered.

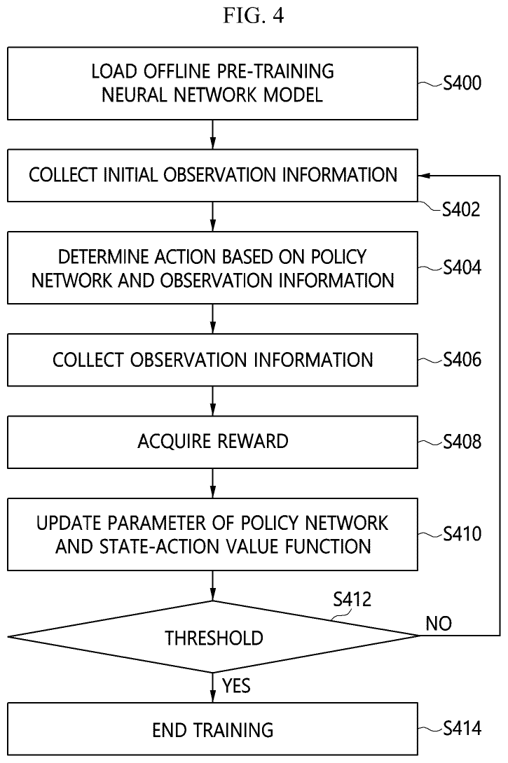

FIG. 4 is a diagram illustrating a flowchart of an online fine-tuning process according to the present embodiment.

Referring to FIG. 4, the online model training unit 104 loads a neural network model that has been pre-trained offline in step 300 (step 400) and collects initial observation information (step 402).

Thereafter, the action is determined based on the policy network and initial observation information of the pre-trained neural network model (step 404).

The online model training unit 104 collects the observation information at the next time point according to the action (step 406) and acquires a reward using the state information, the action information, and the observation information at the next time point (step 408).

Based on the acquired reward, the parameters of the newly built state-action value function network according to the pre-trained policy network and adaptation are updated (step 410), and the training ends by determining whether the preset number of times of training has been met (step 412).

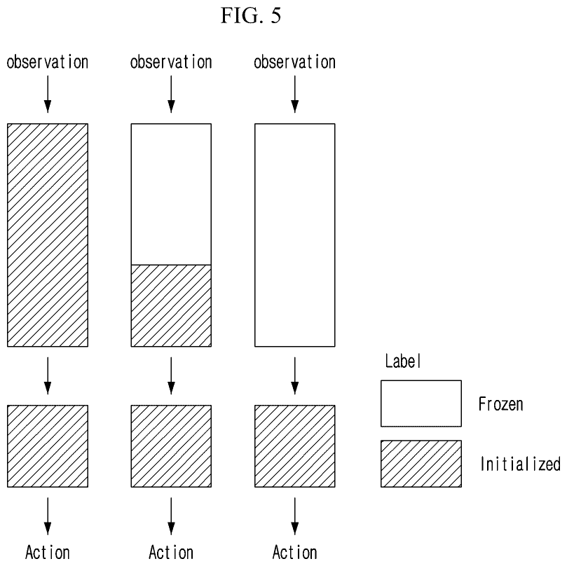

The online model training unit 104 requires state-action value function network parameter initialization and policy network parameter initialization (model initialization), and in the case of the model initialization, there is a method of completely initializing a model or a method of partially initializing a model, as illustrated in FIG. 5.

In addition, according to the present embodiment, after the offline model learning, the adaptation of the state-action value function network is performed to improve the pre-trained model into a model suitable for a specific domain.

The adaptation of the state-action value function network is for building a new state-action value function network that matches the offline policy network.

In this case, the training requires the pre-trained policy and the offline dataset, and the purpose of the adaptation is to build the state-action value function that is well aligned with the trained policy and at the same time is not regulated by the offline methodology. The step may be additionally inserted in the middle of the offline learning and the online learning.

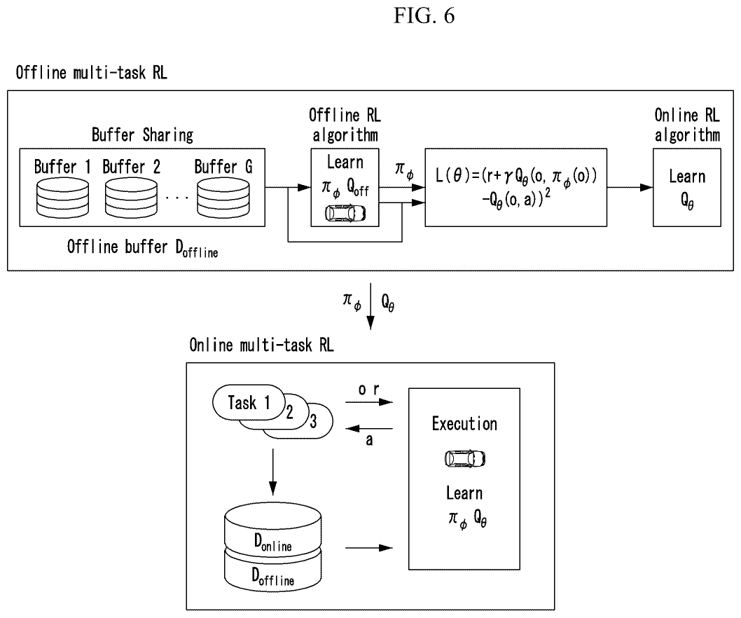

FIG. 6 is a diagram illustrating an offline pre-training and online fine-tuning framework based on reinforcement learning according to a preferred embodiment of the present disclosure.

Referring to FIG. 6, the offline model training unit 102 trains an offline policy network π_{ϕ} and a state-action value function network Q_{off} using the previously collected dataset stored in the offline buffer by the data management unit 100.

Thereafter, prior to the online model learning, the adaptation of the pre-trained policy-based state-action value function network is performed through the offline reinforcement learning.

In the adaptation of the state-action value function network, the objective function is the same as in Equation 4.

Thereafter, the online model training unit 104 performs the online fine-tuning using the previously collected dataset and the data collected online and Q_{θ} trained through the offline policy network π_{ϕ} and the adaptation of the state-action value function network.

As a result of applying the offline pre-training and online fine-tuning method based on reinforcement learning according to the present embodiment to the autonomous driving and the drone network, it may be confirmed that it shows high performance.

The offline pre-training and online fine-tuning method based on reinforcement learning described above may also be implemented in the form of a recording medium including program instructions executable by a computer, such as an application or program module executed by the computer. The program instructions may be stored in memory connected to the processor. A computer-readable medium may be any available media that may be accessed by a computer and includes both volatile and nonvolatile media and removable and non-removable media. Also, the computer-readable medium may include all computer storage media. The computer storage medium includes both volatile and nonvolatile and removable and non-removable media implemented by any method or technology for storage of information such as computer readable instructions, data structures, program modules, or other data.

The embodiments of the present disclosure described above have been disclosed for illustrative purposes, and those skilled in the art with ordinary knowledge of the present disclosure will be able to make various modifications, changes, and additions within the spirit and scope of the present disclosure, and these modifications, changes, and additions should be regarded as falling within the scope of the following claims.

What is claimed is:

1. An offline pre-training and online fine-tuning apparatus based on reinforcement learning, comprising:
a data management unit collecting and processing data for offline reinforcement learning in advance;
an offline model training unit training an offline policy network and an offline state-action value function network using a previously collected dataset that includes a state, an action, a next state, a reward, and an accumulated reward collected by the data management unit; and
an online model training unit performing fine-tuning to update parameters of the offline policy network using an online dataset that includes action information determined based on state information acquired through interaction with the offline policy network and an environment, state information at a next time point according to the action information, and the reward, and the previously collected dataset.

2. The offline pre-training and online fine-tuning apparatus of claim 1, wherein the offline model training unit performs adaptation for constructing a new state-action value function network matching the offline policy network, and
the online model training unit updates parameters of the new state-action value function network according to the offline policy network and the adaptation using the online dataset and the previously collected dataset.

3. The offline pre-training and online fine-tuning apparatus of claim 2, wherein the online model training unit initializes all or at least a part of the parameters of the new state-action value function according to the offline policy network and the adaptation.

4. The offline pre-training and online fine-tuning apparatus of claim 1, wherein the data management unit collects observation information and action information through observation equipment,
matches the observation information and the action information with observation information at a next time point,
calculates a reward using the matched observation information, action information, and observation information at the next time point, and
stores the observation information, the action information, the observation information at the next time point, and the reward as the previously collected dataset.

5. The offline pre-training and online fine-tuning apparatus of claim 1, wherein the offline model training unit samples at least some data from the previously collected dataset,
calculates and updates an objective function of a state-action value function network that evaluates a value of a specific state-action pair using the sampled data, and
calculates and updates the objective function of the offline policy network.

6. The offline pre-training and online fine-tuning apparatus of claim 1, wherein the online model training unit loads the offline policy network pre-trained by the offline model training unit,
collects initial observation information,
determines an action using the offline policy network and the initial observation information,
collects observation information at a next time point according to the determined action,
acquires a reward using the initial observation information, the action, and the observation information at a next time point, and
updates the parameters of the offline policy network using the initial observation information, the action, the observation information at the next time point, and the reward.

7. An offline pre-training and online fine-tuning apparatus based on reinforcement learning, comprising:
a processor; and
a memory connected to the processor,
wherein the memory collects data for offline reinforcement learning in advance,
process the collected data into a previously collected dataset that includes a state, an action, a next state, a reward, and an accumulated reward,
train an offline policy network and an offline state-action value function network using the previously collected dataset, and
update parameters of the offline policy network using an online dataset that includes action information determined based on state information acquired through interaction with the offline policy network and an environment, state information at a next time point according to the action information, and the reward, and the previously collected dataset.

8. An offline pre-training and online fine-tuning method based on reinforcement learning performed on a device including a processor and a memory, comprising the steps of:
(a) collecting and processing data for offline reinforcement learning in advance;
(b) training an offline policy network and an offline state-action value function network using a previously collected dataset that includes a state, an action, a next state, a reward, and an accumulated reward collected by a data management unit; and
(c) performing fine-tuning to update parameters of the offline policy network using an online dataset that includes action information determined based on state information acquired through interaction with the offline policy network and an environment, state information at a next time point according to the action information, and the reward, and the previously collected dataset.

9. The offline pre-training and online fine-tuning method of claim 8, wherein the step of (b) further includes performing adaptation for constructing a new state-action value function network matching the offline policy network, and
The step of (c) includes updating parameters of the new state-action value function network according to the offline policy network and the adaptation using the online dataset and the previously collected dataset.

10. The offline pre-training and online fine-tuning method of claim 9, wherein the step of (c) further includes initializing all or at least a part of the parameters of the offline policy network and the new state-action value function network.

11. The offline pre-training and online fine-tuning method of claim 8, wherein the step of (a) includes:
collecting observation information and action information through observation equipment;
matching the observation information and the action information with observation information at a next time point;
calculating a reward using the matched observation information, action information, and observation information at the next time point; and
storing the observation information, the action information, the observation information at the next time point, and the reward as the previously collected dataset.

12. The offline pre-training and online fine-tuning method of claim 8, wherein the step of (c) includes:
sampling at least a part of data from the previously collected dataset;
calculating and updating an objective function of a state-action value function network that evaluates a value of a specific state-action pair using the sampled data; and
calculating and updating the objective function of the offline policy network.

13. The offline pre-training and online fine-tuning method of claim 8, wherein the step of (c) includes:
loading a pre-trained offline policy network in the step of (b);
collecting initial observation information;
determining an action using the offline policy network and the initial observation information;
collecting observation information at a next time point according to the determined action;
acquiring a reward using the initial observation information, the action, and the observation information at a next time point; and
updating the parameters of the offline policy network using the initial observation information, the action, the observation information at the next time point, and the reward.
